(19) United States
(12) Patent Application Publication
(10) Pub. No.: US 2017/0026792 A1
(43) Pub. Date: Jan. 26, 2017

(54) UNINTRUSIVE POSITION TRACKING USING PHYSICAL RANDOM ACCESS CHANNEL

(71) Applicant: QUALCOMM Incorporated, San Diego, CA (US)

(72) Inventors: Tejinder Dip SINGH, Hyderabad (IN); Aimer BHAT, Bangalore (IN); Venu PAKALAPATY, Bangalore (IN)

(21) Appl. No.: 15/080,918

(22) Filed: Mar. 25, 2016

(30) Foreign Application Priority Data
Jul. 23, 2015 (IN) 3796/CHE/2015

(51) Int. Cl. H04W 4/02; H04W 74/04; H04W 74/00

(52) U.S. Cl. CPC H04W 4/023; H04W 74/006; H04W 74/004; H04W 74/04

(57) ABSTRACT

Certain aspects of the present disclosure generally relate to position tracking of user equipment (UEs) using physical random access channel (PRACH) signals. According to certain aspects, a method is provided for wireless communications which may be performed, for example, by a base station (BS). The method generally includes communicating resources allocated for a physical random access channel (PRACH), a preamble sequence to be transmitted by a user equipment (UE) in the PRACH, and frame reference timings to neighboring cells; using a template based detector for PRACH to compute a timing advance using a shifted sequence that is closest to a profile of the preamble sequence received in the PRACH, and computing a first distance to the UE based on the computed timing advance.

### CROSS-REFERENCE TO RELATED APPLICATIONS

The present Application for Patent claims priority to Indian Patent Application No. 3796/CHE/2015, titled “UNINTRUSIVE POSITION TRACKING USING PHYSICAL RANDOM ACCESS CHANNEL” and filed Jul. 23, 2015, which is assigned to the assignee of the present application and hereby expressly incorporated by reference herein in its entirety.

### BACKGROUND

Field of the Disclosure

Certain aspects of the present disclosure relate generally to wireless communication systems, and more specifically, to position tracking of user equipment (UEs) using physical random access channel (PRACH) signals.

Description of Related Art

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Downlink Packet Data (HSDPA), which provides higher data transfer speeds and capacity to associated UMTS networks.

In addition to operation in wireless telecommunication systems in which wireless service is afforded through disparate base stations, a UE can consume data related to various services such as location-based services. Based on technology or provisioning settings (e.g., enabled functionality) of the UE, position of the UE can be estimated at least in part by the UE through data received from a plurality of satellites, or from control signaling received from a plurality of base stations. In 3GPP LTE networks, such control signaling data includes a positioning reference signal (PRS), which is transmitted by the plurality of base stations and received by the UE. In telecommunication systems, a UE's position can be determined by the UE supplying to the network measurements regarding the time of arrival of the PRS. For a UE's position to be determined, the UE must have an active (e.g., powered-on) receiver to receive the signals and use a processor to compute differences in times of arrival of the various signals. Thus, locating a UE may require the UE to consume power, reducing the battery life of the UE. In addition, a UE that has been specially programmed may not supply true measurements to the network, inhibiting the UE from being located, e.g., by law enforcement agencies.

There is therefore a need to track the position of UEs without the UE supplying true measurements to the network.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and user terminals in a wireless network.

According to certain aspects of the present disclosure, a method for locating a user equipment (UE) performed by a base station (BS) is provided. The method generally includes communicating resources allocated for a physical random access channel (PRACH), a preamble sequence to be transmitted by the UE in the PRACH, and frame reference timings to neighboring cells, using a template based detector for PRACH to compute a timing advance using a shifted sequence that is closest to a profile of the preamble sequence received in the PRACH, and computing a first distance to the UE based on the computed timing advance.

According to certain aspects of the present disclosure, an apparatus for locating a user equipment (UE) is provided. The apparatus generally includes a processor configured to communicate resources allocated for a physical random access channel (PRACH), a preamble sequence to be transmitted by the UE in the PRACH, and frame reference timings to neighboring cells, to use a template based detector for PRACH to compute a timing advance using a shifted sequence that is closest to a profile of the preamble sequence received in the PRACH, and to compute a first distance to the UE based on the computed timing advance, and a memory coupled with the processor.

According to certain aspects of the present disclosure, an apparatus for locating a user equipment (UE) is provided. The apparatus generally includes means for communicating resources allocated for a physical random access channel (PRACH), a preamble sequence to be transmitted by the UE in the PRACH, and frame reference timings to neighboring cells, means for using a template based detector for PRACH to compute a timing advance using a shifted sequence that is closest to a profile of the preamble sequence received in the PRACH, and means for computing a first distance to the UE based on the computed timing advance.

According to certain aspects of the present disclosure, a computer readable medium storing computer executable code for locating a user equipment (UE) is provided. The code generally includes instructions for communicating resources allocated for a physical random access channel (PRACH), a preamble sequence to be transmitted by the UE in the PRACH, and frame reference timings to neighboring cells, instructions for using a template based detector for PRACH to compute a timing advance using a shifted sequence that is closest to a profile of the preamble sequence received in the PRACH, and instructions for computing a first distance to the UE based on the computed timing advance.

Numerous other aspects are provided including apparatus, systems, computer program products and computer-readable media. To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a telecommunications system, in accordance with certain aspects of the present disclosure.

FIG. 2 is a block diagram conceptually illustrating an example of a Node B in communication with a user equipment (UE) in a telecommunications system, in accordance with certain aspects of the present disclosure.

FIG. 3 illustrates an example frame structure, in accordance with certain aspects of the present disclosure.

FIG. 4 illustrates example subframe formats and for cell-specific reference signal (CRS) transmission, in accordance with certain aspects of the present disclosure.

FIGS. 5-5A illustrate example subframe formats for positioning reference signal (PRS) transmission, in accordance with certain aspects of the present disclosure.

FIG. 6 is a block diagram conceptually illustrating an example of a telecommunications system, in accordance with certain aspects of the present disclosure.

FIG. 7 is a block diagram conceptually illustrating an example of a telecommunications system, in accordance with certain aspects of the present disclosure.

FIG. 8 illustrates example operations performed, for example, by a BS, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure generally relate to techniques for tracking the location of a user equipment (UE). According to aspects of the present disclosure, a base station (BS) may: communicate resources allocated for a physical random access channel (PRACH), a preamble sequence to be transmitted by a UE in the PRACH, and frame reference timings to neighboring cells; use a template based detector for PRACH to compute a timing advance using a shifted sequence that is closest to a profile of the preamble sequence received in the PRACH; and compute a first distance to the UE based on the computed timing advance. According to aspects of the present disclosure, a BS may generate a plurality (e.g., 839) of shifted waveforms by shifting a PRACH preamble sequence by one or more samples and determine which shifted waveform is closest to the PRACH signal received from the UE. By comparing the received PRACH signal to the shifted waveforms, the BS may determine the time for the PRACH signal to travel from the UE to the BS with a precision of one sample. In an LTE system, a sample is determined based on the size of the discrete Fourier transform, for example, 2048, and the subcarrier spacing in the frequency domain, for example, 15 kHz. Using the examples, the size of a sample is 1/(2048·15 kHz), or approximately 32.5 nanoseconds. Determining the time for the PRACH signal to travel from the UE to the BS to that precision may enable a BS to determine the distance to the UE with a precision of 9.77 m.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma 2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

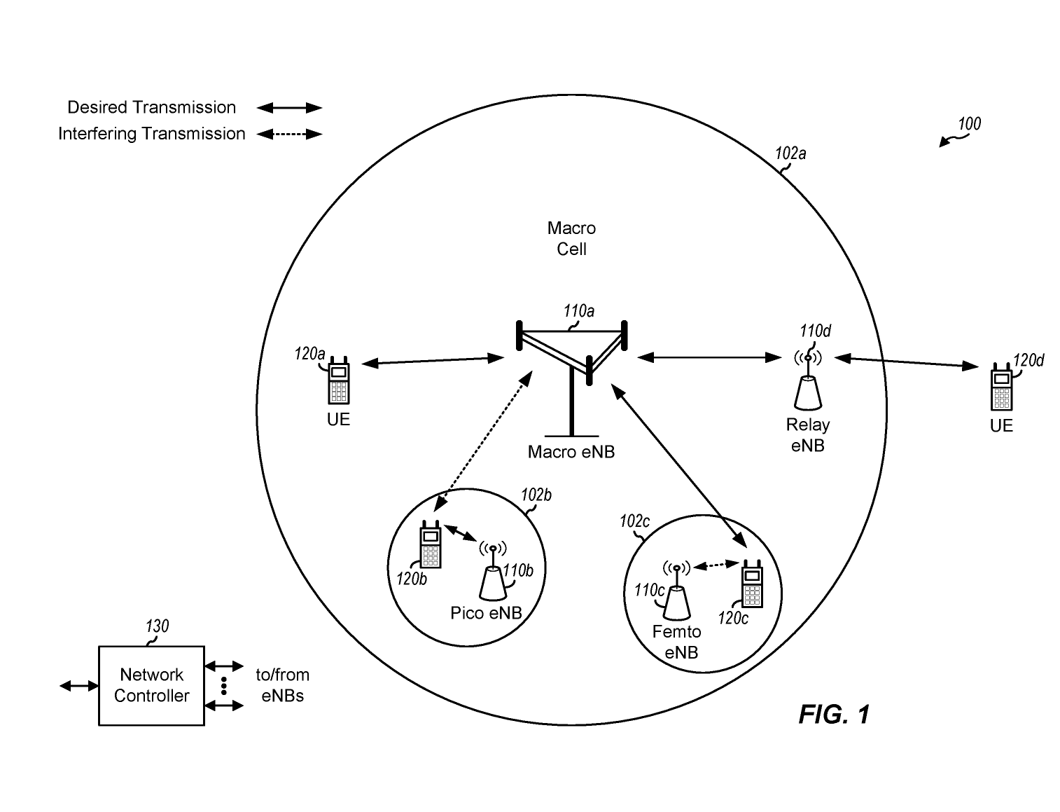

FIG. 1 shows a wireless communication network 100. The network 100 may be an LTE network or some other wireless network. Wireless network 100 may include a number of evolved Node Bs (eNBs) 110 and other network entities. An eNB is an entity that communicates with UEs and may also be referred to as a base station, a Node B, an access point, etc. Each eNB may provide communication coverage for a particular geographic area. In 3GPP, the term “cell” can refer to a coverage area of an eNB and/or an eNB subsystem serving this coverage area, depending on the context in which the term is used. In some aspects, a UE can serve as an access point.

An eNB may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG)). An eNB for a macro cell may be referred to as a macro eNB. An eNB for a pico cell may be referred to as a pico eNB. An eNB for a femto cell may be referred to as a femto eNB or a home eNB (HeNB). In the example shown in FIG. 1, an eNB 110a may be a macro eNB for a macro cell 102a, an eNB 110b may be a pico eNB for a pico cell 102b, and an eNB 110c may be a femto eNB for a femto cell 102c. An eNB may support one or multiple (e.g., three) cells. The terms “eNB”, “base station” and “cell” may be used interchangeably herein.

Wireless network 100 may also include relay stations. A relay station is an entity that can receive a transmission of data from an upstream station (e.g., an eNB or a UE) and send a transmission of the data to a downstream station (e.g., a UE or an eNB). A relay station may also be a UE that can relay transmissions for other UEs. In the example shown in FIG. 1, a relay station 110d may communicate with macro eNB 110a and a UE 120d in order to facilitate communication between eNB 110aand UE 120d. A relay station may also be referred to as a relay eNB, a relay base station, a relay, etc.

Wireless network 100 may be a heterogeneous network that includes eNBs of different types, e.g., macro eNBs, pico eNBs, femto eNBs, relay eNBs, etc. These different types of eNBs may have different transmit power levels, different coverage areas, and different impact on interference in wireless network 100. For example, macro eNBs may have a high transmit power level (e.g., 5 to 40 Watts) whereas pico eNBs, femto eNBs, and relay eNBs may have lower transmit power levels (e.g., 0.1 to 2 Watts).

A network controller 130 may couple to a set of eNBs and may provide coordination and control for these eNBs. Network controller 130 may communicate with the eNBs via a backhaul. The eNBs may also communicate with one another, e.g., directly or indirectly via a wireless or wireline backhaul.

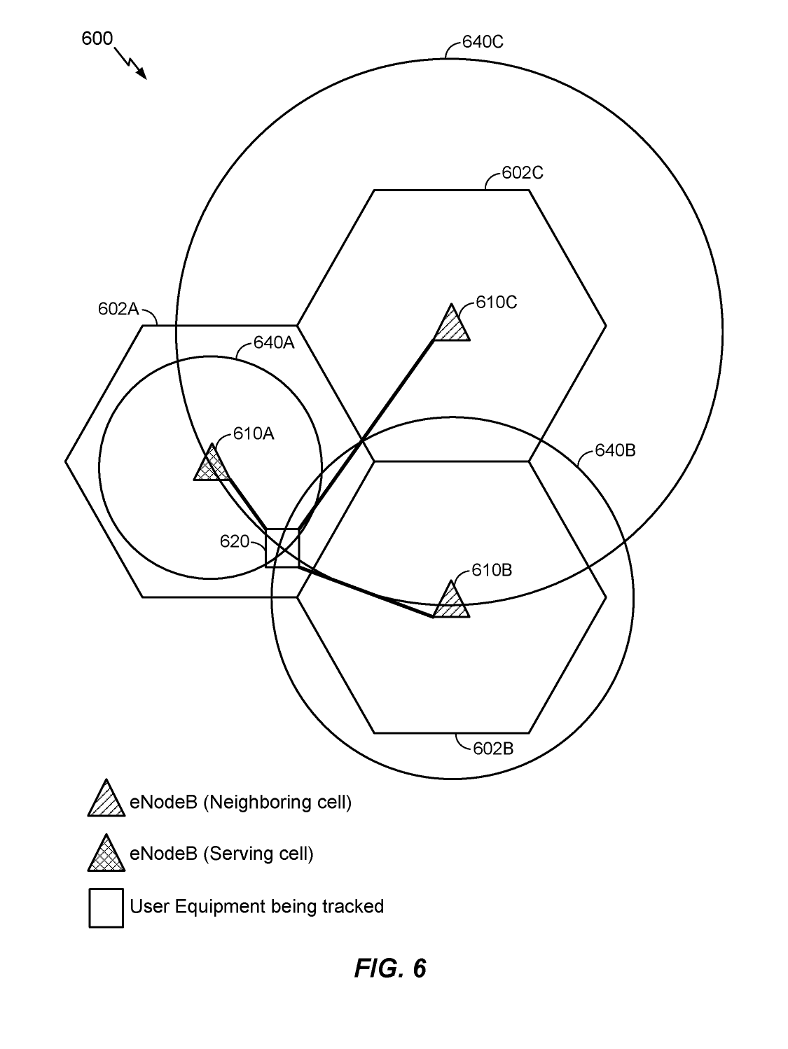

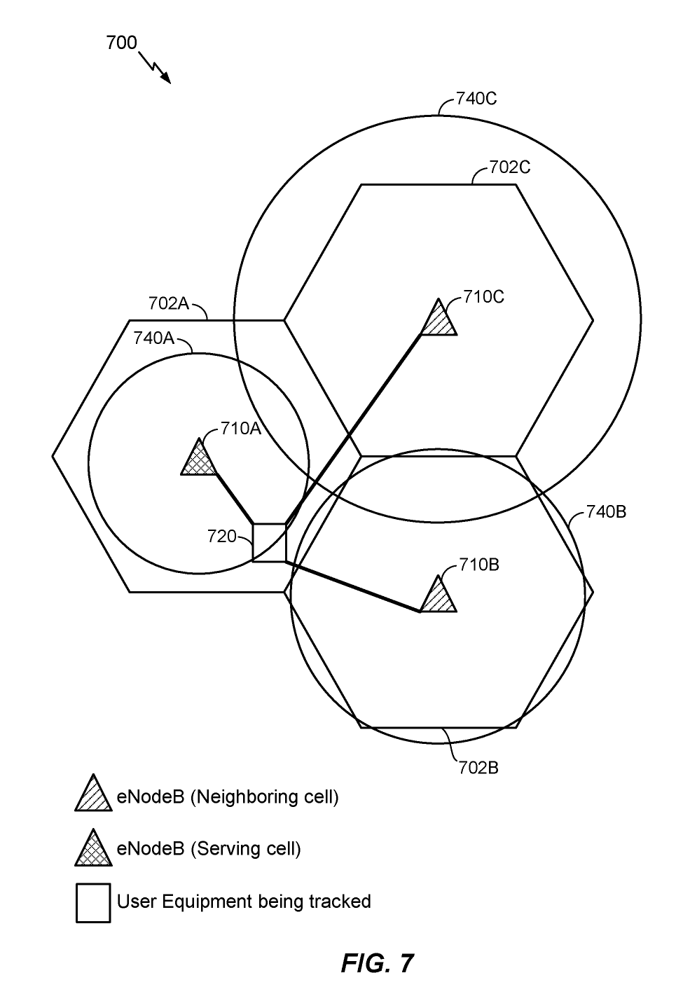

A location services (LCS) server 140 may couple to a set of eNBs and the network controller 130 and provide location services to the network. “Location services” refers to techniques for determining the location of UEs communicating with the network. The LCS server may determine the location of a UE by sending commands to one or more eNBs to request the UE to report time difference of arrival (TDOA) data based on position reference signals (PRS) transmitted by one or more eNBs, as described in more detail below with reference to FIGS. 6-7. The LCS server may use the OTDOA data and known locations of the eNBs to determine the location of the UE. Additionally or alternatively, the functions of the LCS server may be performed by the network controller, an eNB, or another network entity.

UEs 120 may be dispersed throughout wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a tablet, a netbook, a smartbook, an ultrabook, a wearable device (e.g., smart watch, wristband, bracelet, ring, clothing), a drone, a robot, a meter, a monitor, a sensor, etc.

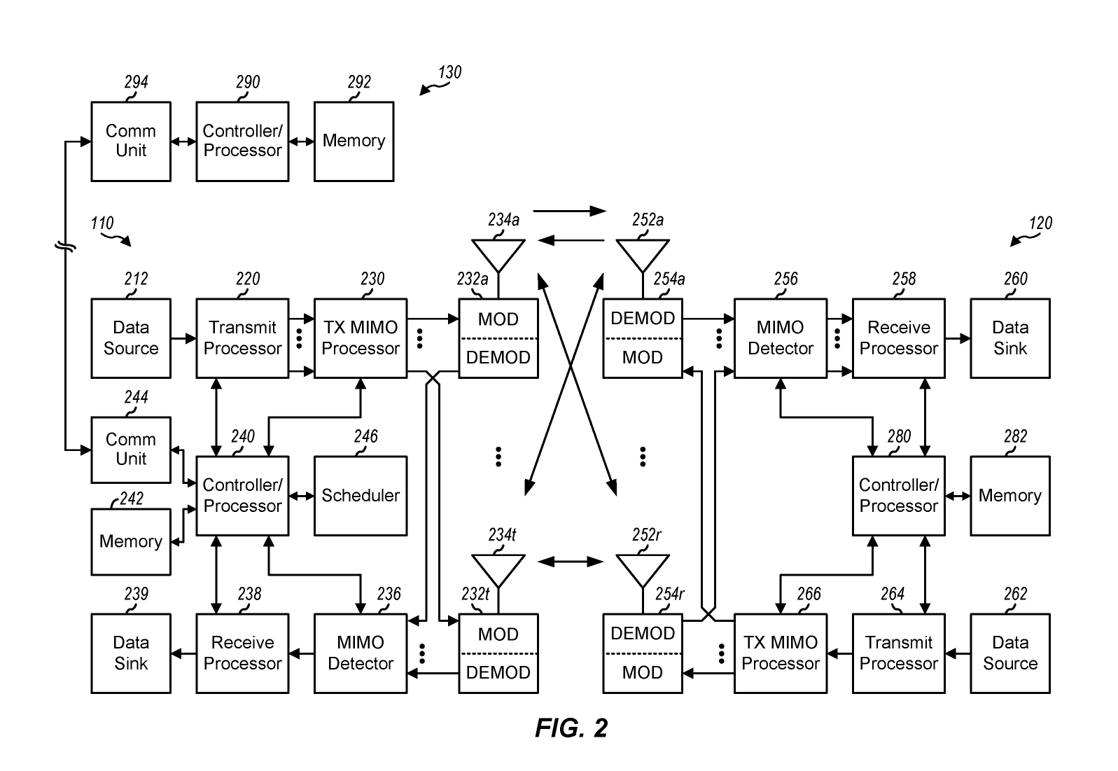

FIG. 2 shows a block diagram of a design of base station/eNB 110 and UE 120, which may be one of the base stations/eNBs and one of the UEs in FIG. 1. Base station 110 may be equipped with T antennas 234a through 234t, and UE 120 may be equipped with R antennas 252a through 252r,

At base station 110, a transmit processor 220 may receive data from a data source 212 for one or more UEs, select one or more modulation and coding schemes (MCS) for each UE based on channel quality information (CQIs) received from the UE, process (e.g., encode and modulate) the data for each UE based on the modulation and coding scheme selected for the UE, and provide data symbols for all UEs. Transmit processor 220 may also process system information and control information (e.g., CQI requests, grants, upper layer signaling, etc.) and provide overhead symbols and control symbols. Processor 220 may also generate reference symbols for reference signals (e.g., the cell-specific reference signals) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) its received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280.

On the uplink, at UE 120, a transmit processor 264 may receive and process data from a data source 262 and control information from controller/processor 280. Processor 264 may also generate reference symbols for one or more reference signals. The symbols from transmit processor 264 may be precoded by a TX MIMO processor 266 if applicable, further processed by modulators 254a through 254r (e.g., for single-carrier frequency division multiplexing (SC-FDM), orthogonal frequency division multiplexing (OFDM), etc.), and transmitted to base station 110. At base station 110 the uplink signals from UE 120 and other UEs may be received by antennas 234 processed by demodulators 232, detected by a MIMO detector 236 if applicable, and further processed by a receive processor 238 to obtain decoded data and control information sent by UE 120. Processor 238 may provide the decoded data to a data sink 239 and the decoded control information to controller/processor 240.

Controllers/processors 240 and 280 may direct the operation at base station 110 and UE 120, respectively. For example, processor 240 and/or other processors and modules at base station 110 may perform or direct operations for configuring a base station to perform operations, e.g., operations 700 shown in FIG. 7. For example, processor 240 and/or other processors and modules at base station 110 may perform or direct operations for various communicating, using, and computing procedures or functions. For example, processor 280 and/or other processors and modules at UE 120 may perform or direct operations for configuring a UE to perform operations. Memory 242 and memory 282 may store data and program codes for base station 110 and UE 120, respectively. A scheduler 244 may schedule UEs for data transmission on the downlink and/or uplink.

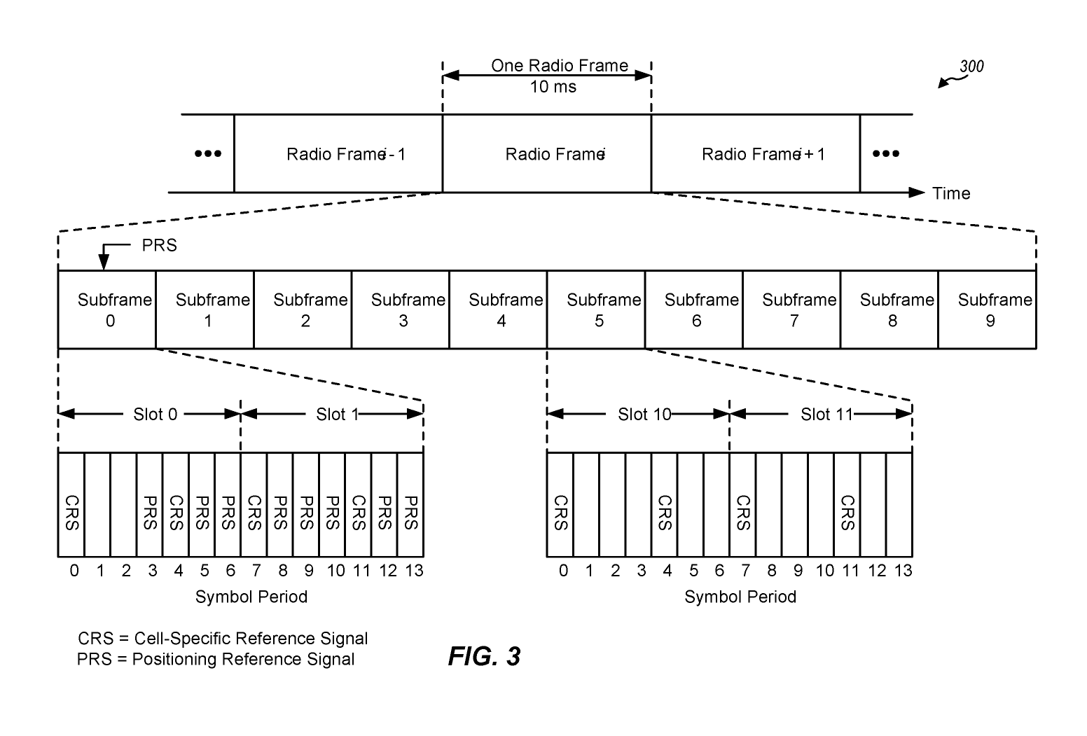

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix or six symbol periods for an extended cyclic prefix. The 2 L symbol periods in each subframe may be assigned indices of 0 through 2 L-1.

LTE utilizes OFDM on the downlink and SC-FDM on the uplink. OFDM and SC-FDM partition a frequency range into multiple (N_{FFT}) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N_{FFT}) may be dependent on the system bandwidth. For example, N_{FFT} may be equal to 128, 256, 512, 1024 or 2048 for system bandwidth of 1.4, 3, 5, 10 or 20 megahertz (MHz), respectively.

The time-frequency resources available for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

FIG. 3 shows transmission of reference signals in LTE, according to aspects of the present disclosure. A cell may transmit a cell-specific reference signal (CRS) in certain symbol periods of each subframe. The cell may transmit a positioning reference signal (PRS) in certain symbol periods of certain subframes. The CRS and PRS may be specific for the cell and may be generated based on a cell identity (ID) of the cell. The CRS and PRS may be used for various purposes such as channel estimation, channel measurement, channel feedback reporting, etc.

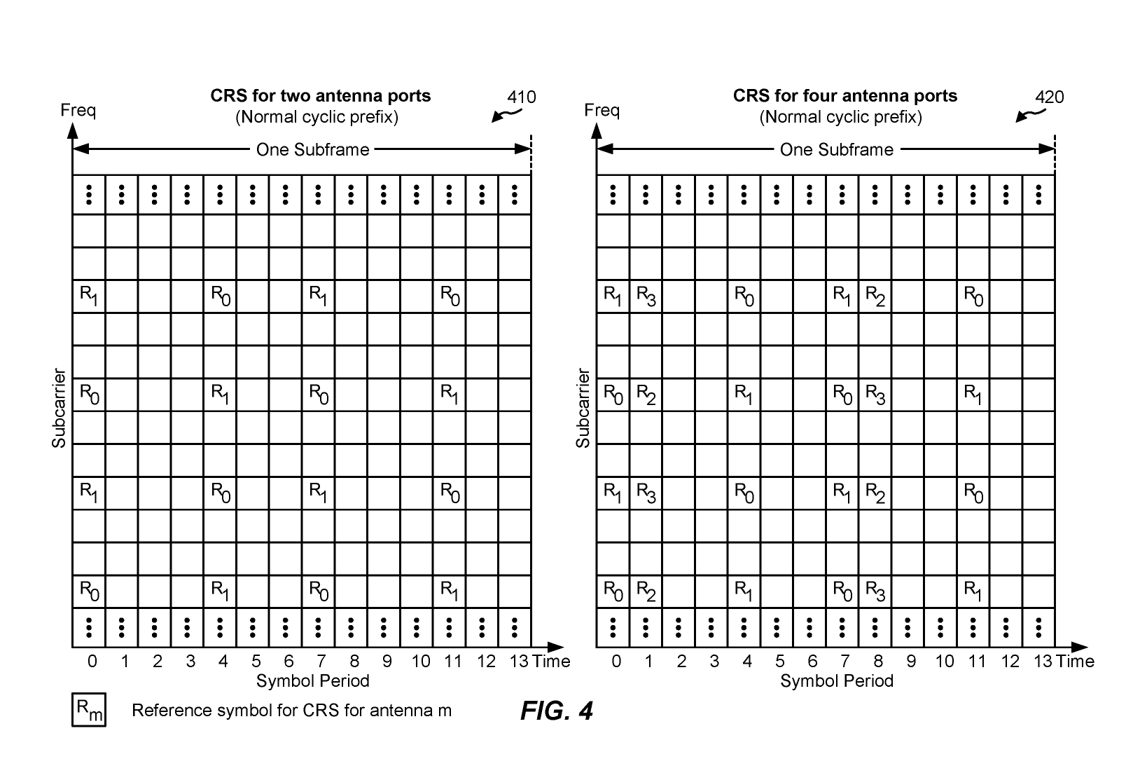

FIG. 4 shows two subframe formats 410 and 420 for the CRS with the normal cyclic prefix in LTE, according to aspects of the present disclosure. Subframe format 410 may be used for a cell having two antenna ports. The cell may transmit a CRS in symbol periods 0, 4, 7 and 11. Subframe format 420 may be used by a cell having four antenna ports. The cell may transmit a CRS in symbol periods 0, 1, 4, 7, 8 and 11. For both subframe formats 410 and 420, for a given resource element with label Rₘ, a reference symbol may be transmitted on that resource element from antenna port m, and no modulation symbols may be transmitted on that resource element from other antenna ports. An antenna port may also be referred to as an antenna, an antenna element, etc. A cell may transmit the CRS on evenly spaced subcarriers in each symbol period in which the CRS is transmitted.

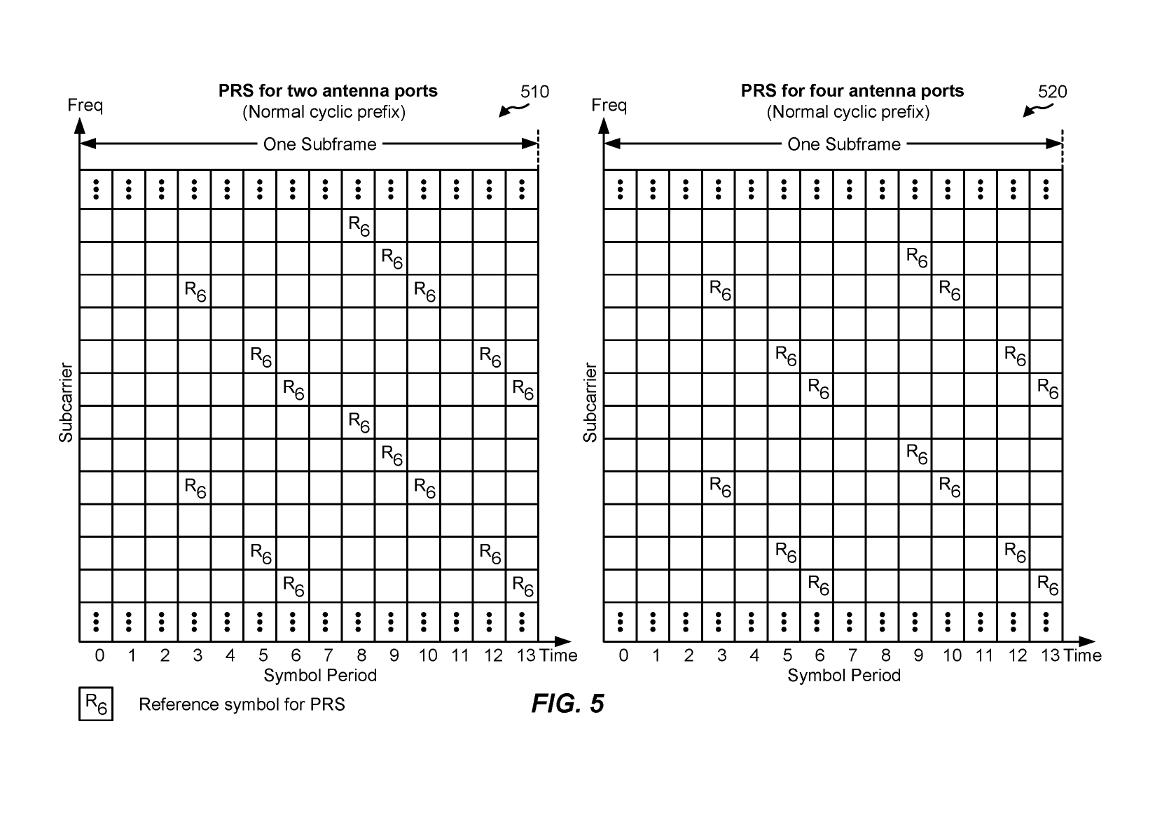

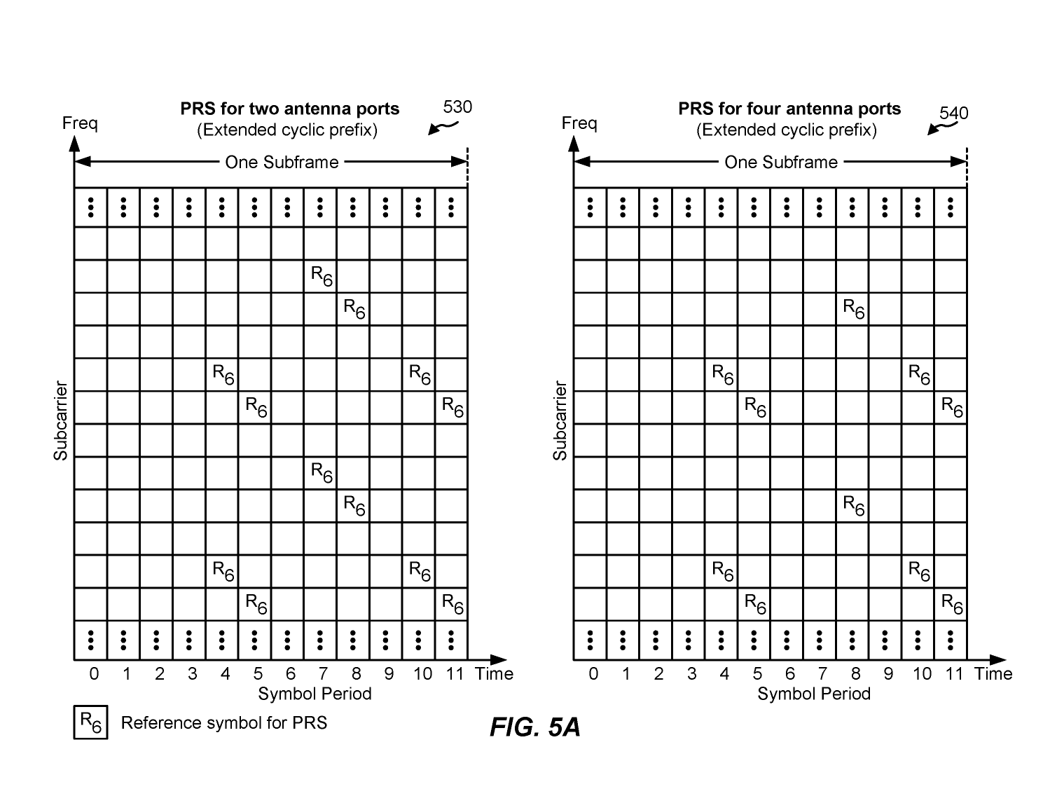

FIG. 5 shows two subframe formats 510 and 520 for the PRS with the normal cyclic prefix in LTE, according to aspects of the present disclosure. A subframe may include 14 symbol periods with indices 0 to 13 for the normal cyclic prefix. Subframe format 510 may be used for a cell having one or two antenna ports.

Subframe format 520 may be used for a cell having four antenna ports. For both subframe formats 510 and 520, a cell may transmit the PRS on antenna port 6 on each resource element with label R₆ in FIG. 5.

FIG. 5A shows two subframe formats 530 and 540 for the PRS with the extended cyclic prefix in LTE, according to aspects of the present disclosure. A subframe may include 12 symbol periods with indices 0 to 11 for the extended cyclic prefix. Subframe format 530 may be used for a cell having one or two antenna ports. Subframe format 540 may be used for a cell having four antenna ports. For both subframe formats 530 and 540, a cell may transmit the PRS on antenna port 6 on each resource element with label R₆ in FIG. 5A.

A cell may transmit the PRS from antenna port 6 on one or more resource blocks in each subframe configured for PRS transmission. The cell may avoid transmitting the PRS on resource elements allocated to the PBCH, a primary synchronization signal (PSS), or a secondary synchronization signal (SSS) regardless of their antenna ports. The cell may generate reference symbols for the PRS based on a cell ID, a symbol period index, and a slot index. A UE may be able to distinguish the PRS from different cells, for example, by determining the cell ID from a received PRS.

A cell may transmit the PRS over a particular PRS bandwidth, which may be configured by higher layers. The cell may transmit the PRS on subcarriers spaced apart by six subcarriers across the PRS bandwidth, e.g., as shown in FIGS. 5 and 5A. The cell may also transmit the PRS based on the parameters listed in Table 1.

TABLE 1
Parameters for PRS

| Parameter | | Description |
|---|---|---|
| T_{PRS} | PRS periodicity | Periodicity at which the PRS is transmitted. |
| Δ_{PRS} | Subframe offset | Indicate specific subframes in which the PRS is |
| | | transmitted. |
| N_{PRS} | PRS duration | Number of consecutive subframes in which the |
| | | PRS is transmitted in each period of PRS |
| | | transmission. |

The PRS periodicity may be 160, 320, 640, or 1280 ms. That is, a base station may transmit a set of PRS every 0.16 seconds, 0.32 seconds, 0.64 seconds, or 1.28 seconds. The PRS duration may be 1, 2, 4 or 6 ms. The PRS periodicity T_{PRS} and the subframe offset A_{PRS} may be conveyed via a PRS configuration index I_{PRS}. An exemplary table of PRS configuration indices and their meanings is shown in Table 2. The PRS configuration index and the PRS duration may be configured independently by higher layers.

TABLE 2
PRS Configuration Indices

| PRS configuration | PRS periodicity T_{PRS} | PRS subframe offset Δ_{PRS} |
|---|---|---|
| index I_{PRS} | (subframes) | (subframes) |
| 0-159 | 160 | I_{PRS} |
| 160-479 | 320 | I_{PRS} - 160 |
| 480-1119 | 640 | I_{PRS} - 480 |
| 1120-2399 | 1280 | I_{PRS} - 1120 |

| | |
|---|---|
| 2400-4095 | Reserved |

A set of N_{PRS} consecutive subframes in which the PRS is transmitted may be referred to as a PRS occasion. Each PRS occasion may be enabled or muted for a UE, for example, the UE may apply a muting bit to each cell. Cells that may be muted in the next PRS occasion should not be measured by the UE.

Techniques and apparatus are provided herein for position tracking (e.g., locating) UEs through the use of physical random access channel (PRACH) signals. A BS may receive a PRACH signal from a UE and generate a plurality of shifted sequences by shifting a PRACH preamble sequence by one or more samples to create each shifted sequence. By comparing the shifted sequences with the received PRACH preamble sequence, the BS can determine the time for the PRACH signal to travel to the BS from the UE with high precision, e.g., within 32.5 nanoseconds. Determining the time for the PRACH signal to travel from the UE to the BS with such precision may allow the BS to determine the distance to the UE with a precision of 9.77 m. Additionally or alternatively, the BS may send the time, for the PRACH signal to travel from the UE to the BS, to an LCS server (e.g., LCS server 140 shown in FIG. 1) or another network entity providing location services. The LCS server or other network entity may use times reported by one or more BSs to determine a location of a UE.

FIG. 6 illustrates an exemplary wireless communications system 600 in which aspects of the present disclosure may be practiced. Communications system 600 includes 3 eNBs 610a, 610b, and 610c, although the disclosure is not so limited and more or fewer eNBs may be included in wireless communications systems practicing disclosed techniques. The eNBs 610a, 610b, and 610c serve the cells 602a, 602b, and 602c, respectively. The eNBs may be similar to eNB 110 in FIG. 1. Similarly, the cells may be similar to the cell 102 in FIG. 1.

For simplicity, FIG. 6 shows a single UE 620, although more UEs may be present in wireless communications systems practicing disclosed techniques. The eNBs may cooperate to determine a location for the UE by each eNB determining a distance to the UE and exchanging information regarding the distances from each eNB to the UE.

If the distances from a first BS (e.g., eNB 610a) and a second BS (e.g., eNB 610b) to a UE (e.g., UE 620) are determined (e.g., by comparing a received PRACH sequence to a shifted sequence, as described above), then there are two possible locations of the UE, which may be determined by drawing circles (e.g., circles 640a and 640b) around the location of the first BS and the location of the second BS, with radii equal to the determined distances, and locating the at most two intersections of the two circles. If the distance from a third BS (e.g., eNB 610c) to the UE is also known, then drawing a third circle (e.g., circle 640c) around the location of the third BS with radius equal to the third distance and locating the intersection of the three circles locates the position of the UE. The process of using distances from three locations to determine another location is referred to as trilateration.

As mentioned above, in long term evolution (LTE), location positioning (e.g., of UEs) may be performed through observed time difference of arrival (OTDOA) estimations. A location positioning server indicates a list of neighbor cells to a user equipment (UE). The UE may measure the time of arrival (TOA) for each cell in the list and may report a time difference of arrival (TDOA) with respect to a reference cell to the network. Given the UE's observed time difference of arrival, the location positioning server in the network may determine the position of the UE by, for example, trilateration. The accuracy of OTDOA estimations may improve with a greater number of neighboring cells from which PRS are received by the UE, as the UE may report TOAs for each neighboring cell from which the UE receives PRS.

A network entity (e.g., a BS) using OTDOA techniques to locate a UE is dependent on the UE supplying accurate time measurements. Some UEs, (e.g., UEs which have been specially programmed) may supply inaccurate time measurements to the network entities, causing the network entities to fail to locate the UE. Law enforcement agencies may desire a technique to locate a UE which supplies inaccurate time measurements to network entities. In addition, a UE being located by OTDOA techniques must operate a receiver to receive the PRS, operate a processor to calculate the time measurements, and transmit the time measurements to the BS. The UE consumes power to perform all of those actions, and this power consumption may reduce the battery life of the UE.

FIG. 7 illustrates an exemplary wireless communication system 700 that may use OTDOA techniques to locate UEs. The eNBs 710a, 710b, and 710c serve the cells 702a, 702b, and 702c, respectively. The eNBs may be similar to eNB 110 in FIG. 1. Similarly, the cells may be similar to the cell 102 in FIG. 1. For simplicity, FIG. 7 shows a single UE 720, although more UEs may be present in wireless communications systems practicing disclosed techniques. The eNBs may cooperate to determine a location for the UE by each eNB determining a distance to the UE and exchanging information regarding the distances from each eNB to the UE.

In the exemplary wireless communications system 700, the UE 720 has been specially programmed to supply inaccurate time measurements when requested to report TOAs (i.e., when the network is attempting to determine a location of the UE). As above with reference to FIG. 6, when a network entity is attempting to locate the UE, the UE may be requested to report TOA information for each of the base stations 710a, 710b, and 710c. The UE may report an accurate time measurement with respect to a first (e.g., serving) eNB 710a, and inaccurate time measurements with respect to a second eNB 710b and third eNB 710c. If the distances from a first BS (e.g., eNB 710a) and a second BS (e.g., eNB 710b) to the UE are determined based on TOA information reported by the UE, some of which may be inaccurate, then computing circles (e.g., circles 740a and 740b) around the location of the first BS and the location of the second BS, with radii equal to the determined distances, may result in the circles not intersecting, as illustrated. If the distance from a third BS (e.g., eNB 710c) to the UE is also determined based on inaccurate TOA information reported by the UE, then computing a third circle (e.g., circle 740c) around the location of the third BS with radius equal to the third distance may intersect with one or both of the other computed circles, as illustrated. However, none of the intersections of the computed circles is the actual location of the UE, and trilateration with respect to the UE may be unsuccessful.

In LTE networks, when a UE attempts to connect to a BS, the UE transmits a PRACH signal to the BS. The UE transmits the PRACH signal after receiving signals (e.g., PSS, SSS, master information block (MIB)) from which the UE determines the appropriate timing to transmit the PRACH signal. If the UE transmits the PRACH signal with inappropriate timing, then the BS may not detect the PRACH signal. If the BS does not detect the PRACH signal, then the UE will not be able to connect to the BS.

When a BS detects a PRACH signal from a UE, the BS determines a timing advance for the UE to use when transmitting to the BS. The timing advance is a period of time that the UE should begin transmitting before the time the UE detects as the beginning of a subframe. That is, when the UE receives a grant of resources for transmission, the grant will comprise a number of subcarriers in the frequency domain and a number of subframes in the time domain. The UE detects the timing of subframes based on signals received from the BS. The UE should begin transmitting (e.g., an uplink transmission) before the detected beginning of a subframe by an amount equal to the timing advance. By doing so, the UE can ensure that the transmission arrives at the BS at the beginning of the subframe according to the BS's timing, and the BS will be able to receive the transmission.

In current (e.g., LTE) wireless communications standards, the BS determines the timing advance by comparing the received PRACH signal to a preamble sequence and determining a period of time that maximizes the correlation between the received PRACH signal and the preamble sequence. Typically, the BS determines the timing advance with a precision of approximately fifteen samples.

According to aspects of the present disclosure, a BS may receive a PRACH sequence from a UE and determine the time required for the PRACH sequence to travel from the UE to the BS with a precision of one sample. The BS may generate a plurality of shifted waveforms by shifting a PRACH preamble sequence by one or more samples to generate each shifted waveform. The BS may then compare the received PRACH signal to each of the shifted waveforms and determine which shifted waveform is closest to the profile of the received PRACH sequence. The BS can determine the time required for the PRACH sequence to travel from the UE to the BS based on which shifted waveform is closest to the profile of the received PRACH sequence. The BS can then compute a distance to the UE, based on the determined time.

According to aspects of the present disclosure, a network entity (e.g., a BS) may determine a first distance from a first BS to a UE according to the techniques disclosed above and receive a second distance from a second BS, wherein the second distance is the distance of the UE from the second BS. The network entity may also receive a third distance from a third BS, wherein the third distance is the distance of the UE from the third BS. The network entity may determine a location of the UE based on the first distance, the second distance, the third distance, a location of the network entity, a location of the second BS, and a location of the third BS. The network entity may determine the location of the UE by trilateration, wherein the network entity computes a circle around the locations of each of the three base stations and determines the location of the UE to be at the intersection of the three circles. The network entity uses the first distance as a radius of the first circle around the first BS. Similarly, the network entity uses the second distance as the radius of the second circle around the second BS and the third distance as the radius of the third circle around the third BS.

A BS that is not a serving BS of a UE may use similar techniques of determining a correlation between a received PRACH sequence and a waveform of a shifted preamble sequence to determine a distance to the UE. However, a BS that is not a serving BS of the UE may be a long distance from the UE, possibly more than the radius of the cell served by the BS (e.g., more than 14 km). A BS receiving a PRACH sequence from a UE that is farther away than the radius of the cell served by the BS may detect the PRACH sequence as being a different PRACH sequence. That is, due to the distance from the UE to the BS, the BS may detect a PRACH sequence that was transmitted as configuration index x (e.g., 14) as configuration index y (e.g., 30). In addition, the BS may incorrectly determine the time period required for the PRACH sequence to travel from the UE to the BS.

According to aspects of the present disclosure, a serving BS may send (e.g., via an X2 interface) an indication of a configuration index of a PRACH sequence to be transmitted by a UE and the time the UE is to transmit the PRACH sequence to one or more other base stations. A second BS, receiving the indication of the configuration index of the PRACH sequence and the time the UE is to transmit the PRACH sequence may use the indications in detecting the PRACH sequence transmitted by the UE. The second BS may use the indication of the configuration index to accurately determine the time of arrival of the received PRACH sequence by comparing the received PRACH sequence with shifted sequences based on the configuration index obtained from the serving BS. The second BS may then use the indicated transmission time in determining the time required for the PRACH sequence to travel from the UE to the second BS. The second BS may also refrain from scheduling transmissions (e.g., transmissions by the second BS or UEs served by the second BS) during the time the UE is to transmit the PRACH sequence, in order to reduce interference and allow the second BS a better chance to receive the PRACH sequence.

According to aspects of the present disclosure, a serving BS may request a UE to transmit a PRACH sequence, and, when the UE transmits the PRACH sequence, use the PRACH sequence received from the UE in locating the UE. The BS may request the UE to transmit a contention-free PRACH sequence, wherein the BS indicates to the UE a PRACH sequence for the UE to transmit, which may be reserved. By doing so, the BS can ensure that no other UE in the BS's cell transmits the same PRACH sequence and prevent interference with the PRACH sequence transmitted by the UE.

Additionally or alternatively, an LCS server or other network entity providing location services may obtain times for the PRACH sequence to travel from a UE from three or more BSs, compute distances based on the obtained times, and determine a location of the UE by using trilateration techniques with the computed distances and known locations of the BSs. Also additionally or alternatively, an LCS server or other network entity providing location services may obtain computed distances from three or more BSs, wherein each BS computes a distance based on the time for the PRACH sequence to travel from the UE to the BS. The LCS server or other network entity providing location services may determine a location of the UE by using trilateration techniques with the computed distances and known locations of the BSs.

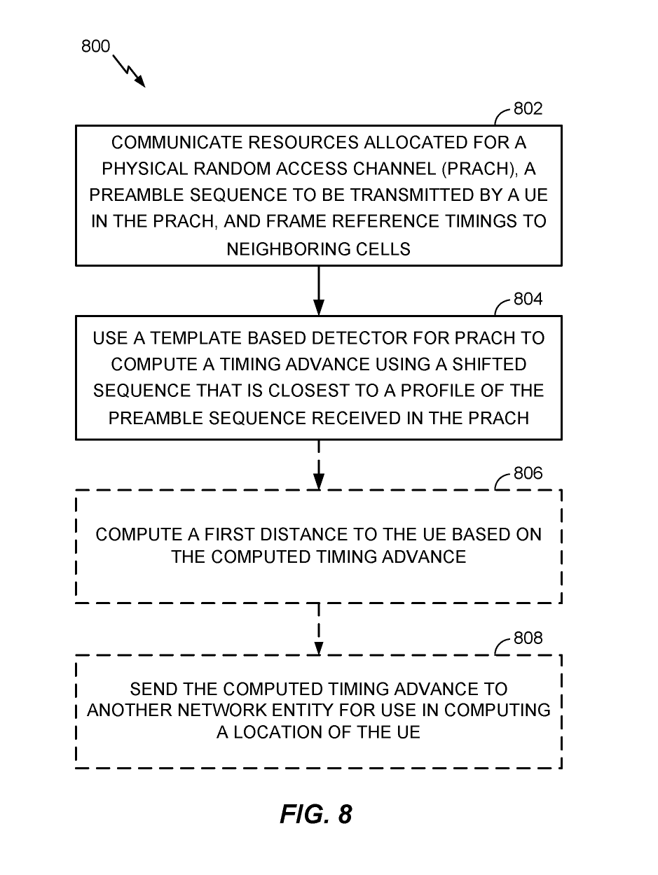

FIG. 8 illustrates example operation 800 for locating a user equipment (UE) performed by a first base station (BS), according to aspects of the present disclosure described above. Operation 800 may be performed, for example, by an eNB (e.g., eNB 110 in FIG. 2, eNB 610a in FIG. 6).

The operation 800 may begin, at 802 by the first BS communicating resources allocated for a physical random access channel (PRACH), a preamble sequence to be transmitted by the UE in the PRACH, and frame reference timings to neighboring cells. The resources allocated, preamble sequence, and frame reference timings may be communicated to neighboring cells via X2 interfaces, for example. At 804, the first BS may use a template based detector for PRACH to compute a timing advance using a shifted sequence that is closest to a profile of the preamble sequence received in the PRACH. Optionally, at 806, the first BS may compute a first distance to the UE based on the computed timing advance. Also optionally, at 808, the first BS may send the computed timing advance to another network entity (e.g., an LCS server) for use in computing a location of the UE.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b,b-b-c, c-c, and c-c-c or any other ordering of a, b, and c).

The various operations or methods described above may be performed by any suitable means capable of performing the corresponding functions. The means may include various hardware and/or software component(s) and/or module(s), including, but not limited to a circuit, an application specific integrated circuit (ASIC), or processor.

For example, means for transmitting, sending, or communicating may comprise a transmitter (e.g., the transceiver front end 254 of the user terminal 120 depicted in FIG. 2 or the transceiver front end 232 of the access point 110 shown in FIG. 2) and/or an antenna (e.g., the antennas 252a through 252r of the user terminal 120 portrayed in FIG. 2 or the antennas 234a through 234t of the access point 110 illustrated in FIG. 2). Means for receiving or communicating may comprise a receiver (e.g., the transceiver front end 254 of the user terminal 120 depicted in FIG. 2 or the transceiver front end 232 of the access point 110 shown in FIG. 2) and/or an antenna (e.g., the antennas 252a through 252r of the user terminal 120 portrayed in FIG. 2 or the antennas 234a through 234t of the access point 110 illustrated in FIG. 2). Means for processing, means for determining, means for using, or means for computing may comprise a processing system, which may include one or more processors, such as any of the processors illustrated in FIG. 2.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software is construed broadly to mean instructions, data, or any combination thereof, whether referred to as software, firmware, middleware, microcode, hardware description language, or otherwise.

According to certain aspects, such means may be implemented by processing systems configured to perform the corresponding functions by implementing various algorithms (e.g., in hardware or by executing software instructions).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in combinations thereof A software module may reside in any form of storage medium that is known in the art. Some examples of storage media that may be used include random access memory (RAM), read only memory (ROM), flash memory, phase change memory (PCM), EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For example, the instructions may be executed by a processor or processing system of the user terminal 120 or access point 110 and stored in a memory 282 of the user terminal 120 or memory 242 of the access point 110. For certain aspects, the computer program product may include packaging material.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for locating a user equipment (UE) performed by a first base station (BS), comprising:
communicating resources allocated for a physical random access channel (PRACH), a preamble sequence to be transmitted by the UE in the PRACH, and frame reference timings to neighboring cells; and
using a template based detector for PRACH to compute a timing advance using a shifted sequence that is closest to a profile of the preamble sequence received in the PRACH.

2. The method of claim 1, further comprising:
computing a first distance to the UE based on the computed timing advance.

3. The method of claim 2, further comprising:
receiving a second distance, wherein the second distance is a distance of the UE from a second BS;
receiving a third distance, wherein the third distance is a distance of the UE from a third BS;
determining a location of the UE, based on the first distance, the second distance, and the third distance.

4. The method of claim 3, further comprising:
sending an indication of time and frequency resources used by the UE to transmit the preamble sequence to the second BS and the third BS; and
sending an indication of the preamble sequence to the second BS and the third BS.

5. The method of claim 1, further comprising:
sending the computed timing advance to another network entity for use in computing a location of the UE.

6. The method of claim 1, wherein the UE transmits the preamble sequence in response to a request from the first BS for the UE to transmit a contention-free PRACH sequence.

7. An apparatus for locating a user equipment (UE), comprising:
a processor configured to:
communicate resources allocated for a physical random access channel (PRACH), a preamble sequence to be transmitted by the UE in the PRACH, and frame reference timings to neighboring cells; and
use a template based detector for PRACH to compute a timing advance using a shifted sequence that is closest to a profile of the preamble sequence received in the PRACH; and
a memory coupled with the processor.

8. The apparatus of claim 7, wherein the processor is further configured to:
compute a first distance to the UE based on the computed timing advance.

9. The apparatus of claim 8, wherein the processor is further configured to:
receive a second distance, wherein the second distance is a distance of the UE from a second BS;
receive a third distance, wherein the third distance is a distance of the UE from a third BS;
determine a location of the UE, based on the first distance, the second distance, and the third distance.

10. The apparatus of claim 9, wherein the processor is further configured to:
send an indication of time and frequency resources used by the UE to transmit the preamble sequence to the second BS and the third BS; and
send an indication of the preamble sequence to the second BS and the third BS.

11. The apparatus of claim 7, wherein the processor is further configured to:
send the computed timing advance to another network entity for use in computing a location of the UE.

12. The apparatus of claim 7, wherein the UE transmits the preamble sequence in response to a request from the first BS for the UE to transmit a contention-free PRACH sequence.

13. An apparatus for locating a user equipment (UE), comprising:
means for communicating resources allocated for a physical random access channel (PRACH), a preamble sequence to be transmitted by the UE in the PRACH, and frame reference timings to neighboring cells; and
means for using a template based detector for PRACH to compute a timing advance using a shifted sequence that is closest to a profile of the preamble sequence received in the PRACH.

14. The apparatus of claim 13, further comprising:
means for computing a first distance to the UE based on the computed timing advance.

15. The apparatus of claim 14, further comprising:
means for receiving a second distance, wherein the second distance is a distance of the UE from a second BS;
means for receiving a third distance, wherein the third distance is a distance of the UE from a third BS;
means for determining a location of the UE, based on the first distance, the second distance, and the third distance.

16. The apparatus of claim 15, further comprising:
means for sending an indication of time and frequency resources used by the UE to transmit the preamble sequence to the second BS and the third BS; and
means for sending an indication of the preamble sequence to the second BS and the third BS.

17. The apparatus of claim 13, further comprising:
means for sending the computed timing advance to another network entity for use in computing a location of the UE.

18. The apparatus of claim 13, wherein the UE transmits the preamble sequence in response to a request from the first BS for the UE to transmit a contention-free PRACH sequence.

19. A computer readable medium storing computer executable code for locating a user equipment (UE), the code comprising instructions for:
communicating resources allocated for a physical random access channel (PRACH), a preamble sequence to be transmitted by the UE in the PRACH, and frame reference timings to neighboring cells; and
using a template based detector for PRACH to compute a timing advance using a shifted sequence that is closest to a profile of the preamble sequence received in the PRACH.

20. The computer readable medium of claim 19, further comprising instructions for:
computing a first distance to the UE based on the computed timing advance.

21. The computer readable medium of claim 20, the code further comprising instructions for:
receiving a second distance, wherein the second distance is a distance of the UE from a second BS;
receiving a third distance, wherein the third distance is a distance of the UE from a third BS;
determining a location of the UE, based on the first distance, the second distance, and the third distance.

22. The computer readable medium of claim 21, the code further comprising instructions for:
sending an indication of time and frequency resources used by the UE to transmit the preamble sequence to the second BS and the third BS; and
sending an indication of the preamble sequence to the second BS and the third BS.

23. The computer readable medium of claim 19, further comprising instructions for:
sending the computed timing advance to another network entity for use in computing a location of the UE.

24. The computer readable medium of claim 19, wherein the UE transmits the preamble sequence in response to a request from the first BS for the UE to transmit a contention-free PRACH sequence.
